(19) United States
(12) Patent Application Publication
(10) Pub. No.: US 2025/0207236 A1
(43) Pub. Date: Jun. 26, 2025

(54) FLAT STEEL PRODUCT HAVING AN AL COATING, METHOD FOR THE PRODUCTION THEREOF, STEEL COMPONENT, AND METHOD FOR PRODUCTION THEREOF

(71) Applicant: THYSSENKRUPP STEEL EUROPE AG, Duisburg (DE)

(72) Inventors: David Hoffmann, Bergkamen (DE); Fabian Junge, Wesel (DE)

(21) Appl. No.: 18/850,761

(22) PCT Filed: Apr. 20, 2022
(86) PCT No.: PCT/EP2022/060357

§ 371 Date: Sep. 25, 2024

(51) Int. Cl. C23C 2/12; C22C 21/10; C22C 38/02; C22C 38/04; C22C 38/06; C23C 2/28; C23C 2/40

(52) U.S. Cl. CPC C23C 2/12; C22C 21/10; C22C 38/02; C22C 38/04; C22C 38/06; C23C 2/28; C23C 2/40

(57) ABSTRACT

A steel component includes a steel substrate composed of a steel having 0.1-3 wt. % of Mn and optionally up to 0.01 wt. % of B, and an Al-based protective coating applied to the steel substrate. The protective coating has an overall iron- and manganese-free proportion by mass of up to 30% of additional alloy constituents, by mass of Si in the protective coating as additional alloy constituent is between 3 wt. % and 15 wt. % Si, by mass of Mg in the protective coating as additional alloy constituent is up to 1.0 wt. % Mg, and by mass of Zn in the protective coating as additional alloy constituent is between 0.4 wt. % and 25.0 wt. % Zn. The protective coating has a near-surface first Zn-rich layer having a Zn content higher than an average Zn content of the protective coating, and the Zn content of the first Zn-rich layer is more than 5 wt. %.

The invention relates to a flat steel product for hot forming, consisting of a steel substrate which composed of a steel which comprises 0.1-3% by weight of Mn and optionally up to 0.01% by weight of B, and an Al-based protective coating applied to the steel substrate and optionally containing a total of up to 30% by weight of other alloy elements.

The invention likewise relates to a steel component and to a method of producing such a steel component.

The expression “flat steel product” here includes all rolled products having a length very much greater than their thickness. These include steel strips and sheets, and (precut) blanks obtained therefrom.

In the course of hot forming, also called press hardening or hot press hardening, steel blanks that have been divided from a cold- or hot-rolled steel strip are heated to a forming temperature generally above the austenitization temperature (Ac3) of the respective steel and placed into the mold of a forming press in the heated state. In the course of the forming operation conducted subsequently, the sheet metal blank, or the component formed therefrom, is subject to rapid cooling as a result of contact with the mold at low temperature. The cooling rates are adjusted here so as to result in a hardness microstructure in the steel substrate. The microstructure is transformed to a martensitic microstructure, referred to as hardness microstructure.

Typical steels that are suitable for hot press hardening are steels A-E, the chemical composition of which is listed in table 10.

For hot-rolled MnB steel sheets that have been provided with an Al coating and are intended for production of steel components by hot forming, EP 0 971 044 B1 specifies an alloying method by which an MnB steel, aside from iron and unavoidable impurities (in % by weight), should have a carbon content of more than 0.20%, but less than 0.5%, a manganese content of more than 0.5%, but less than 3%, a silicon content of more than 0.1%, but less than 0.5%, a chromium content of more than 0.01%, but less than 1%, a titanium content of less than 0.2%, an aluminum content of less than 0.1%, a phosphorus content of less than 0.1%, a sulfur content of less than 0.05%, and a boron content of more than 0.001%, but less than 0.08%. The Al coating is what is called an AlSi coating, consisting of 9-10% by weight of Si, 2-3.5% by weight of iron and of aluminum as the balance. The coated flat steel products having these characteristics are heated to a heating temperature of more than 700° C. and hold at the heating temperature for a certain hold time. During this heating and holding operation, there is melting of the protective coating and alloying through the protective coating. Iron diffuses here from the steel substrate into the protective coating, so as to form phases having higher thermal stability. The molten protective coating thus solidifies. A solidified, thermally stable protective coating is a prerequisite for the subsequent forming step. In the forming step, the flat steel product is inserted into a compression mold, where it is hot-formed to the steel component, in the course of which it is cooled sufficiently quickly that hardness microstructure forms in the steel substrate of the flat steel product.

The AlSi coating described has the disadvantage that there is very strong oxidation of the aluminum-rich surface in the course of hot forming because of the temperatures. The effect of this aluminum oxide layer is in turn that a subsequent phosphation step works only inadequately. The aluminum oxide layer prevents the formation of firmly adhering metal phosphates in the phosphation, since the process parameters in the phosphation process are typically insufficient to break up the aluminum oxide layer. The resulting steel component in that case is highly prone to cosmetic corrosion. Although this does not impair the structural stability of the steel component, it results in reduced esthetics of the steel component, which is not wanted by the final customer.

DE 10 2009 007 909 A1 discloses a method of producing high-strength steel components, in which, on the one hand, optimized forming characteristics of the coating are assured during the hot forming of the respective flat steel product, and in which, on the other hand, the resultant steel components have optimized cathodic corrosion protection. The steel component of the invention has a zinc-alloyed surface having a zinc content of at least 60% by weight, especially of at least 80% by weight. This results in cathodic corrosion protection that is unambiguously electrochemically detectable.

EP 2 045 360 A1 discloses a method of producing high-strength steel components that have optimized corrosion protection and are especially suitable for use in automobile bodies. After hot forming, there is a zinc-alloyed surface having a zinc content of at least 60% by weight, especially of at least 80% by weight, in a steel component of the invention. This results in cathodic corrosion protection that is unambiguously electrochemically detectable. This results in resistance to corrosion at least comparable to pure zinc coatings.

Zn contents exceeding 25% by weight increase the risk of liquid metal embrittlement. Zinc in the protective coating has the disadvantage of a relatively low melting point. In the course of production of the steel component by hot forming, liquid Zn phases can form. These can firstly penetrate into the steel substrate and contribute to cracking (liquid metal embrittlement), and can secondly stick to forming tools or furnace rollers, which leads to soiling and layer detachment.

It is an object of the present invention to provide a steel component that can be produced by hot forming and has improved phosphation properties.

This object is achieved by a steel component consisting of a steel substrate which composed of a steel which comprises 0.1-3% by weight of Mn and optionally up to 0.01% by weight of B, and an Al-based protective coating applied to the steel substrate and optionally having an overall iron- and manganese-free proportion by mass of up to 30% of additional alloy constituents. The iron- and manganese-free proportion by mass of Si in the protective coating as additional alloy constituent is between 3% and 15% Si, especially between 6% and 12% Si. In addition, the iron- and manganese-free proportion by mass of Mg in the protective coating as additional alloy constituent is up to 1.0% and the iron- and manganese-free proportion by mass of Zn in the protective coating as additional alloy constituent is between 0.4% and 25.0% Zn. In addition, the protective coating has a near-surface first Zn-rich layer having a Zn content higher than the average Zn content of the protective coating. Moreover, the Zn content of the first Zn-rich layer is more than 5% by weight. The protective coating is especially an AlSi coating.

An iron- and manganese-free proportion by mass of an alloy constituent in the protective coating, in the context of this application, is considered to mean the proportion of the total mass of that alloy constituent in the total mass of all elements in the protective coating apart from iron and manganese. The use of the iron- and manganese-free proportion by mass for characterization of the protective coating has the advantage that the numerical values do not change as a result of diffusion of iron and manganese out of the steel substrate. Iron- and manganese-free proportions by mass are reported in [%]. By contrast, element contents based on total mass are reported in the usual manner in [% by weight].

The protective coating thus comprises a proportion of up to 30%, preferably of up to 20%, based on the total mass without iron and manganese, of additional alloy elements, of which 3% to 15% is accounted for by Si, up to 1.0% by Mg and between 0.4% and 25% by Zn.

In particular, the proportion by mass of Mn is more than 0.1% by weight and less than 2.5% by weight, preferably more than 0.2% by weight and preferably less than 2.0% by weight, more preferably more than 0.4% by weight and preferably less than 1.8% by weight. In the hot forming operation, a certain proportion of Mn diffuses out of the steel substrate into the protective coating, where it forms an additional alloy constituent.

Aside from Fe, Si, Mg, Zn and optionally aside from Mn, the protective coating preferably consists solely of Al and unavoidable impurities. In the context of this application, an element is an unavoidable impurity in the protective coating when the iron- and manganese-free proportion by mass in the protective coating is less than 0.5%. This definition relates solely to unavoidable impurities in the protective coating. The standard technical limits are applicable to the unavoidable impurities in the steel substrate that will be mentioned later.

A near-surface layer in the context of this application means a layer that extends over a region having a thickness of 500 nm that adjoins the surface of the protective coating. The first Zn-rich layer thus extends within a region having a thickness of 500 nm that adjoins the surface of the protective coating. In other words, the first Zn-rich layer runs in the uppermost 500 nm of the protective coating.

It has been found that an elevated Zn content in this near-surface region enables reliable phosphation. The near-surface zinc is transformed to zinc phosphates in the course of phosphation. A zinc phosphate layer additionally offers better corrosion protection than an iron phosphate layer that would otherwise form. Moreover, zinc phosphate is an excellent base for adhesion of paint.

The iron- and manganese-free proportion by mass of Zn in the protective coating as additional alloy constituent is preferably at least 0.6%, more preferably at least 1.0%, especially at least 1.5%.

Further preferably, the Zn content of the first Zn-rich layer is more than 10.0% by weight, more preferably more than 18.0% by weight.

The higher the Zn content of the first Zn-rich layer, the better the phosphation characteristics, since more zinc phosphates and fewer iron phosphates will form. With a higher iron- and manganese-free proportion by mass of Zn in the protective coating, it is more easily possible in a procedurally reliable manner to achieve a high Zn content of the first Zn-rich layer. Therefore, a high iron- and manganese-free proportion by mass of Zn in the protective coating is preferred.

However, zinc in the protective coating has the disadvantage of a relatively low melting point. In the course of production of the steel component by hot forming, liquid Zn phases can form. These can firstly penetrate into the steel substrate and contribute to cracking (liquid metal embrittlement), and can secondly stick to forming tools or furnace rollers, which leads to soiling and layer detachment. Therefore, the zinc content chosen cannot be too high either. In experiments, in the flat steel product, iron- and manganese-free proportions by mass of Zn in the protective coating of not more than 5.0%, especially of less than 5%, preferably of not more than 2.3%, more preferably not more than 1.8%, have been found to be particularly favorable.

An advantageous additional alloy constituent in the protective coating has been found to be magnesium, which has good alloy ability into Al protective coatings of the type in question here. The amount of Mg added is adjusted such that the iron- and manganese-free proportion by mass of magnesium adds up to at least 0.10%, preferably at least 0.15%. In particular, iron- and manganese-free proportions by mass of magnesium of less than 0.50% or less than 0.4% or less than 0.35% have been found to be particularly favorable in practice. Magnesium added to the protective coating in small amounts is notable for higher oxygen affinity than the main aluminum constituent of the protective coating. Even in the presence of such small amounts of magnesium, a thin oxide layer is formed at the surface of the protective coating, which covers the aluminum between it and the steel substrate. This thin layer, in the course of the heating required for the hot forming of the flat steel product, prevents reaction of the aluminum with the moisture present in the atmosphere of the furnace used for the heating of the flat steel product. In this way, oxidation of the aluminum in the coating and associated release of hydrogen that could diffuse into the coating and steel substrate of the flat steel product are effectively prevented. This is surprisingly especially true even when the Al-based coating melts locally as a result of the heating and its surface breaks up, such that molten coating material comes into contact with the furnace atmosphere. Especially when annealing times are relatively long, in the case of flat steel products of the invention, a lower concentration of hydrogen in the component hot-formed from the flat steel product is found compared to flat steel products provided conventionally with an Al coating.

Alloying with magnesium therefore has the advantage that this reduces the input of hydrogen into the steel substrate. If a locally very high hydrogen concentration is attained, this weakens binding at the grain boundaries of the steel substrate microstructure to such an extent as to result in a crack along the grain boundary in use as a result of the stress that arises.

The element contents of the protective coating are especially determined by glow discharge optical emission spectroscopy (GD-OES). Alternatively, wet-chemical leaching with subsequent ICP-OES (inductively coupled plasma—optical emission spectrometry) is used to determine the element contents.

The layer thickness of the protective coating is typically in the range of at least 5 μm and at most 35 μm, especially of at least 10 μm and at most 25 m.

The steel substrate is composed of a steel having 0.1-3% by weight of Mn and optionally up to 0.01% by weight of B. In particular, the microstructure of the steel is transformable to a martensitic or partly martensitic microstructure by hot forming. The microstructure of the steel substrate of the steel component is thus preferably a martensitic or at least partly martensitic microstructure, since these have particularly high hardness.

More preferably, the steel substrate is a steel consisting of, as well as iron and unavoidable impurities, (in % by weight)
C: 0.04-0.45% by weight,
Si: 0.02-1.2% by weight,
Mn: 0.5-2.6% by weight,
Al: 0.02-1.0% by weight,
P: ≤0.05% by weight,
S: ≤0.02% by weight,
N: ≤0.02% by weight,
Sn: ≤0.03% by weight,
As: ≤0.01% by weight,
Ca: ≤0.005% by weight,
   and optionally one or more of the elements “Cr, B, Mo, Ni, Cu, Nb, Ti, V” in the following contents:
Cr: 0.08-1.0% by weight,
B: 0.001-0.005% by weight,
Mo: ≤50.5% by weight,
Ni: ≤50.5% by weight,
Cu: ≤50.2% by weight,
Nb: 0.02-0.08% by weight,
Ti: 0.01-0.08% by weight,
V: ≤50.1% by weight.

The elements P, S, N, Sn, As, Ca are impurities that cannot be completely avoided in steel production. As well as these elements, it is also possible for other elements to be present as impurities in the steel. These other elements are referred to collectively as the “unavoidable impurities”. Preferably, the content of unavoidable impurities adds up to not more than 0.2% by weight, preferably not more than 0.1% by weight. The optional alloy elements Cr, B, Nb, Ti, for which a lower limit is specified, may also occur in contents below the respective lower limit as unavoidable impurities in the steel substrate. In that case, they are likewise counted among the unavoidable impurities, the total content of which is limited to not more than 0.2% by weight, preferably not more than 0.1% by weight. The individual upper limits for the respective contamination by these elements are preferably as follows:
Cr: ≤0.050% by weight,
B: ≤0.0005% by weight,
Nb: ≤0.005% by weight,
Ti: ≤0.005% by weight.

These preferred upper limits should be regarded as alternatives or collectively. Preferred variants of the steel thus meet one or more of these four conditions.

In a preferred embodiment, the C content of the steel is not more than 0.37% by weight and/or at least 0.06% by weight. In particular preferred variants, the C content is in the range of 0.06-0.09% by weight or in the range of 0.12-0.25% by weight or in the range of 0.33-0.37% by weight.

In a preferred embodiment of the invention, the Si content of the steel is not more than 1.00% by weight and/or at least 0.06% by weight.

In a preferred variant, the Mn content of the steel is not more than 2.4% by weight and/or at least 0.75% by weight. In particular preferred variants, the Mn content is in the range of 0.75-0.85% by weight or in the range of 1.0-1.6% by weight.

The Al content of the steel in a preferred variant is not more than 0.75% by weight, especially not more than 0.5% by weight, preferably not more than 0.25% by weight. Alternatively or supplementarily, the Al content is preferably at least 0.02%.

In addition, it has been found that it can be helpful when the sum total of the contents of silicon and aluminum is limited. In a preferred variant, therefore, the sum total of the contents of Si and Al (typically referred to as Si30 Al) is not more than 1.5% by weight, preferably not more than 1.2% by weight. Supplementarily or alternatively, the sum total of the contents of Si and Al is at least 0.06% by weight, preferably at least 0.08% by weight.

The elements P, S, N are typical impurities that cannot be completely avoided in steel production. In preferred variants, the P content is not more than 0.03% by weight. Independently of the latter, the S content is preferably not more than 0.012%. Additionally or supplementarily, the N content is preferably not more than 0.009% by weight.

Optionally, the steel additionally contains chromium with a content of 0.08-1.0% by weight. The Cr content is preferably not more than 0.75% by weight, especially not more than 0.5% by weight.

In the case of optional incorporation of chromium in the alloy, the sum total of the contents of chromium and manganese is preferably limited. The sum total is preferably not more than 3.3% by weight, especially not more than 3.15% by weight. In addition, the sum total is at least 0.5% by weight, preferably at least 0.75% by weight.

The steel preferably optionally additionally contains boron with a content of 0.001-0.005% by weight. In particular, the B content is not more than 0.004% by weight.

Optionally, the steel may contain molybdenum with a content of not more than 0.5% by weight, especially not more than 0.1% by weight.

In addition, the steel may optionally contain nickel with a content of not more than 0.5% by weight, preferably not more than 0.15% by weight.

In addition, the steel may optionally contain copper with a content of not more than 0.2% by weight, preferably not more than 0.15% by weight.

In addition, the steel may optionally contain one or more of the microalloying elements Nb, Ti and V. The optional Nb content here is at least 0.02% by weight and at most 0.08% by weight, preferably at most 0.04% by weight. The optional Ti content is at least 0.01% by weight and at most 0.08% by weight, preferably at most 0.04% by weight. The optional V content is at most 0.1% by weight, preferably at most 0.05% by weight.

In the case of optional incorporation of a plurality of the elements Nb, Ti and V in the alloy, the sum total of the contents of Nb, Ti and V is preferably limited. The sum total is preferably not more than 0.1% by weight, especially not more than 0.068% by weight. In addition, the sum total is preferably at least 0.015% by weight.

More preferably, the steel substrate is a steel from the group of steels A-E, the chemical analysis of which is reported in table 10. Table 10 should be understood such that the element contents are reported in percent by weight for each steel from the group of steels A-E. A minimum and a maximum proportion by weight are specified here. For example, steel A thus comprises a carbon content C: 0.05% by weight-0.10% by weight.

The above elucidations relating to preferred steel substrates are of course likewise applicable to the steel substrate of the flat steel product described hereinafter, and the production methods described.

In a preferred variant of the steel component, the surface of the protective coating is formed mainly from Zn accumulations in metallic and/or oxidic form. In the context of this application, the surface of the protective coating is formed mainly from Zn accumulations in metallic and/or oxidic form when it has spot Zn accumulations in more than 50% (area percent), preferably in more than 70%, of the surface area of the protective coating. This proportion can be ascertained, for example, by means of electron micrographs and subsequent image analysis. For each point, both Al and Zn are recorded in accordance with their signal intensity, such that zinc accumulations become apparent.

In a preferred variant of the steel component, the protective coating comprises a low-silicon phase and a silicon-rich phase, where the silicon-rich phase has an insular distribution in the low-silicon phase. The Zn content of the silicon-rich phase is less than 90%, preferably less than 80%, of an average Zn content of the protective coating. At the same time, the Zn content of the low-silicon phase is more than 105%, preferably more than 110%, of the average Zn content of the protective coating.

In other words, the ratio of the proportion by mass of Zn (reported in % by weight) in the silicon-rich phase to the proportion by mass of Zn (reported in % by weight) in the overall protective coating is less than 90%, preferably less than 80%. It is likewise the case that the ratio of the proportion by mass of Zn (reported in % by weight) in the low-silicon phase to the proportion by mass of Zn (reported in % by weight) in the overall protective coating is greater than 105%, preferably greater than 110%.

Concentration of zinc thus takes place in the low-silicon phases, while the zinc content in the silicon-rich phases falls below the average.

In specific configurations, the Si content of the low-silicon phases is less than 10% by weight, preferably less than 7% by weight, more preferably less than 5% by weight.

Further specific configurations have an Si content of the silicon-rich phase of greater than 10% by weight, preferably greater than 12% by weight.

What is meant by “insular” in the context of this application is an arrangement in which discrete noncoherent regions are surrounded by another material—i.e. there are “islands” of a particular material in another material. In a perpendicular metallographic section, the “islands” may have aspect ratios of length to width in the region of 1:1. Length is measured here parallel to the surface, and width at right angles to the surface. The “islands” thus have a similar length and width. However, much greater aspect ratios may also occur, where the length is much greater than the width. The islands thus take the form of streaks.

The object of the invention is likewise achieved by a flat steel product for hot forming, consisting of a steel substrate composed of a steel having 0.1-3% by weight of Mn and optionally up to 0.01% by weight of B, and an Al-based protective coating applied to the steel substrate and optionally having an overall iron- and manganese-free proportion by mass of up to 30% of additional alloy constituents. In addition, the iron- and manganese-free proportion by mass of Si in the protective coating as additional alloy constituent is between 3% and 15% Si, especially between 6% and 12% Si, where the iron- and manganese-free proportion by mass of Mg in the protective coating as additional alloy constituent is between 0.10% and 0.50% Mg, preferably between 0.1% and 0.35% Mg. Moreover, the iron- and manganese-free proportion by mass of Zn in the protective coating as additional alloy constituent is between 0.4% and 5% Zn, preferably between 0.4% and 2.3% Zn.

The protective coating thus comprises a proportion of up to 30%, preferably of up to 20%, based on the total mass without iron and manganese of additional alloy elements, of which 3% to 15% is accounted for by Si, between 0.10% and 0.50% by Mg, and between 0.4% and 2.3% by Zn.

In particular, the proportion by mass of Mn is more than 0.1% by weight and less than 2.5% by weight, preferably between 0.2% by weight and 2.0% by weight and more preferably between 0.4% by weight and 1.8% by weight. Even on application of the protective coating, a certain proportion of Mn can diffuse from the steel substrate into the protective coating, where it forms an additional alloy constituent. This is the case for hot dip coating in particular because of the high temperatures in the melt bath.

Aside from Fe, Si, Mg, Zn and optionally aside from Mn, the protective coating of the flat steel product preferably consists merely of Al and unavoidable impurities. In the context of this application, an element is an unavoidable impurity in the protective coating when the iron- and manganese-free proportion by mass in the protective coating is less than 0.5%. This definition relates merely to unavoidable impurities in the protective coating. The standard technical limits are applicable to the unavoidable impurities in the steel substrate that will be mentioned later.

It has been found that, over and above an iron- and manganese-free proportion by mass of Zn at a level of 0.4% after hot forming, there is a sufficiently high Zn content in the near-surface region to enable reliable phosphation. Near-surface zinc combines in the course of phosphation to form zinc phosphates, which give better corrosion protection than an iron phosphate layer that otherwise forms. Moreover, zinc phosphate is an excellent base for paint adhesion.

The iron- and manganese-free proportion by mass of Zn in the protective coating as additional alloy constituent is preferably at least 0.6%, more preferably at least 1.0%, especially at least 1.5%.

The higher the iron- and manganese-free proportion by mass of zinc, the higher the Zn content in the near-surface region after hot forming as well, and the better the phosphation characteristics, since more zinc phosphates and fewer iron phosphates are formed.

With a higher iron- and manganese-free proportion by mass of Zn in the protective coating, it is therefore possible in a procedurally reliable manner to achieve a high Zn content of the first Zn-rich layer. Therefore, a high iron- and manganese-free proportion by mass of Zn in the protective coating is preferred.

However, zinc in the protective coating has the disadvantage of having a relatively low melting point. In the course of the production of the steel component by hot forming, liquid Zn phases can form. These can firstly penetrate into the steel substrate and contribute to cracking (liquid metal embrittlement), and can secondly stick to forming tools or furnace rollers, which leads to soiling and layer detachment. Therefore, the zinc content chosen cannot be too high either. In experiments, iron- and manganese-free proportions by mass of Zn in the protective coating of not more than 2.3%, preferably not more than 1.8%, have been found to be particularly favorable.

An advantageous additional alloy constituent in the protective coating has been found to be magnesium, which has good alloyability into protective Al coatings of the type in question here. The amount of Mg added is adjusted such that the iron- and manganese-free proportion by mass of magnesium adds up to at least 0.10%, preferably at least 0.15%. In particular, iron- and manganese-free proportions by mass of magnesium of less than 0.50% or less than 0.4% or less than 0.35% have been found to be particularly favorable in practice. Magnesium added to the protective coating in small amounts is notable for higher oxygen affinity than the main aluminum constituent of the protective coating. Even in the presence of such small amounts of magnesium, a thin oxide layer is formed at the surface of the protective coating, which covers the aluminum between it and the steel substrate. This thin layer, in the course of the heating required for the hot forming of the flat steel product, prevents reaction of the aluminum with the moisture present in the atmosphere of the furnace used for the heating of the flat steel product. In this way, oxidation of the aluminum in the coating and associated release of hydrogen that could diffuse into the coating and steel substrate of the flat steel product are effectively prevented. This is surprisingly especially true even when the Al-based coating melts locally as a result of the heating and its surface breaks up, such that molten coating material comes into contact with the furnace atmosphere. Especially when annealing times are relatively long, in the case of flat steel products of the invention, a lower concentration of hydrogen in the component hot-formed from the flat steel product is found compared to flat steel products provided conventionally with an Al coating.

Alloying with magnesium therefore has the advantage that this reduces the input of hydrogen into the steel substrate. If a locally very high hydrogen concentration is attained, this weakens binding at the grain boundaries of the steel substrate microstructure to such an extent as to result in a crack along the grain boundary in use as a result of the stress that arises.

In a particularly preferred variant of the flat steel product, the protective coating has been applied by hot dip coating. Hot dip coating, also referred to in the jargon as “hot dip aluminizing”, is a particularly economically viable method of applying a protective coating.

The layer thickness of the protective coating is typically in the range of at least 5 μm and at most 35 μm, especially of at least 10 and at most 25 μm.

The object of the invention is likewise achieved by a method of producing a phosphated steel component, comprising the following steps:
heating the above-described flat steel product to a heating temperature for the hot forming operation and holding it at the heating temperature, such that diffusion results in concentration of Zn, especially with formation of metallic and oxidic Zn accumulations, in the near-surface region of the protective coating;
hot forming the coated steel substrate to the steel component;
phosphating the hot-formed steel component.

The heating of the above-described flat steel product to a heating temperature for the hot forming operation and the holding at the heating temperature leads to concentration of the Zn in the near-surface region. In particular, this forms a first Zn-rich layer as already elucidated in connection with the steel component, and to formation of oxidic and/or metallic Zn accumulations at the surface of the protective coating that have likewise been elucidated in connection with the steel component. This concentration of Zn in the near-surface region leads to distinctly improved phosphation characteristics and in particular to formation of zinc phosphates rather than iron phosphates.

Preferably, the heating temperature is 830° C. to 980° C., preferably 830° C. to 910° C. In addition, a hold time for which the flat steel product is held at the heating temperature is at least 1 and at most 18 minutes. The heating and holding take place in a furnace.

Hot forming especially comprises the following two partial steps:
discharging the flat steel product from the furnace and placing it in a forming tool;
forming the flat steel product to a steel component in the forming tool.

In order to avoid any great heat losses, the transfer time between furnace and forming tool is typically not more than 10 seconds.

Optionally, the flat steel product can be cooled in the forming tool during the forming operation at cooling rates of 20-1000 K/s, preferably 25-500 K/s, in order to harden the steel substrate.

Alternatively, the flat steel product in the forming tool can firstly be formed to a steel component, and then the steel component can be cooled down at cooling rates of 20-1000 K/s, preferably 25-500 K/s, in order to harden the steel substrate.

In addition, the object of the invention is likewise achieved by a method of producing a phosphated steel component, comprising the following steps:
providing a steel substrate composed of a steel having 0.1-3% by weight of Mn and optionally up to 0.01% by weight of B;
hot dip coating the steel substrate by means of a melt having an Al-based protective coating that optionally has an overall iron- and manganese-free proportion by mass of up to 30% of additional alloy constituents, wherein the iron- and manganese-free proportion by mass of Si in the protective coating as additional alloy constituent is between 3% and 15% Si, especially between 6% and 12% Si, wherein the iron- and manganese-free proportion by mass of Mg in the protective coating as additional alloy constituent is up to 1%, and wherein the iron- and manganese-free proportion by mass of Zn in the protective coating as additional alloy constituent is between 0.4% and 25.0% Zn,
heating the coated steel substrate to a heating temperature for the hot forming operation and holding it at the heating temperature, such that diffusion results in concentration of Zn, especially with formation of metallic and oxidic Zn accumulations, at the surface of the protective coating;
hot forming the coated steel substrate to the steel component;
phosphating the hot-formed steel component.

The iron- and manganese-free proportions by mass here have preferred minimum values and maximum values that have been elucidated above together with their advantages with reference to the steel component.

In particular, the hot dip coating of the steel substrate is effected by means of a melt with an Al-based protective coating that has an overall iron- and manganese-free proportion by mass of up to 30% of additional alloy constituents, wherein the additional alloy constituents include Si, Mg and Zn, wherein the iron- and manganese-free proportion by mass of Si in the protective coating as additional alloy constituent is between 3% and 15% Si, especially between 6% and 12% Si, wherein the iron- and manganese-free proportion by mass of Mg in the protective coating as additional alloy constituent is between 0.10-0.50% Mg, preferably between 0.1-0.35% Mg, and the iron- and manganese-free proportion by mass of Zn in the protective coating as additional alloy constituent is between 0.4-5% Zn, preferably between 0.4-2.3% Zn.

The heating of the above-described flat steel product to a heating temperature for the hot forming operation and the holding at the heating temperature lead to concentration of the Zn in the near-surface region. In particular, this forms a first Zn-rich layer as already elucidated in connection with the steel component, and leads to a formation of oxidic and metallic Zn accumulations at the surface of the protective coating, which have likewise been elucidated in connection with the steel component. This concentration of Zn in the near-surface region leads to distinctly improved phosphation characteristics and especially to formation of zinc phosphates rather than iron phosphates.

Preferably, the heating temperature is 830° C. to 980° C., preferably 830° C. to 910° C. In addition, a hold time for which the flat steel product is held at the heating temperature is at least 1 and at most 18 minutes. The heating and holding take place in a furnace.

The hot forming operation especially comprises the following two partial steps:
discharging the flat steel product from the furnace and placing it in a forming tool;
forming the flat steel product to a steel component in the forming tool.

In order to avoid any great heat losses, the transfer time between furnace and forming tool is typically not more than 10 seconds.

Optionally, the flat steel product can be cooled in the forming tool during the forming operation at cooling rates of 20-1000 K/s, preferably 25-500 K/s, in order to harden the steel substrate.

Alternatively, the flat steel product in the forming tool can firstly be formed to a steel component, and then the steel component can be cooled down at cooling rates of 20-1000 K/s, preferably 25-500 K/s, in order to harden the steel substrate.

Phosphation means full-area phosphation of the steel component, in which a phosphate layer is deposited on the steel component, which, for example, has a thickness of 0.5 to 3.0 m. The phosphate layer increases paint adhesion and reduces corrosion of the steel substrate in the event of paint damage.

In a specific configuration of the aforementioned methods of producing a phosphated steel component, during the heating and holding, diffusion results in formation of a low-silicon phase and a silicon-rich phase, where the silicon-rich phase has an insular distribution in the low-silicon phase. The Zn content of the low-silicon phase here is between 25% and 60%, preferably between 30% and 50%, of the Zn content in the melt.

In a further specific configuration of the aforementioned methods of producing a phosphated steel component, the heating temperature is greater than the Ac3 temperature, such that the microstructure of the steel substrate is in austenitic form. Moreover, the coated steel substrate is quenched after hot forming or in the course of hot forming, such that hardness microstructure is formed in the microstructure of the steel substrate of the flat steel product.

The invention is elucidated in detail by the working examples that follow, in conjunction with the figures. The figures show:

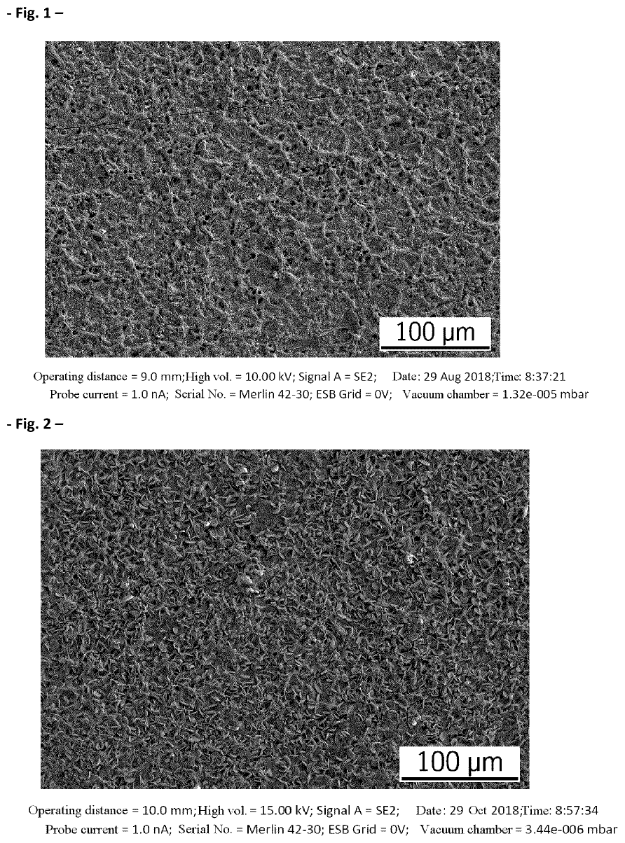

FIG. 1 a scanning electron micrograph of the surface of a hot-formed steel component before phosphation;

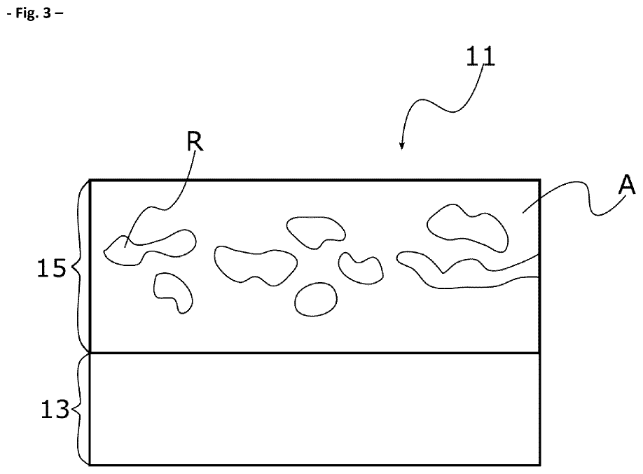

FIG. 2 a scanning electron micrograph of the surface of a hot-formed steel component after phosphation;

FIG. 3 a schematic diagram of a section.

The steel substrate used was a steel sheet having a thickness of 1.5 mm, composed of a steel having a composition according to table 1, with the balance formed by iron and unavoidable impurities. The steel is thus a steel from group D in table 10.

TABLE 1
Steel composition of the steel substrate (in % by weight)

| C | Si | Mn | P | S | Al | Ti | Cr | B |
|---|---|---|---|---|---|---|---|---|
| 0.22 | 0.25 | 1.25 | 0.016 | 0.004 | 0.043 | 0.029 | 0.20 | 0.003 |

On the basis of this steel substrate, four different variants were examined in detail. For this purpose, the steel substrate was first coated with an Al-based protective coating by hot dip coating. The thickness of the protective coating was in each case 20 μm. Table 2 below indicates the target composition of the respective melt, with the balance formed by iron and unavoidable impurities:

TABLE 2
Melt compositions

| | Zinc | Silicon | Aluminum | Magnesium |
|---|---|---|---|---|
| Variant | [% by wt.] | [% by wt.] | [% by wt.] | [% by wt.] |
| A | 0.01 | 10.19 | 87.05 | 0.06 |
| B | 2.26 | 9.71 | 84.98 | 0.43 |
| C | 2.26 | 9.71 | 84.98 | 0.43 |
| D | 0.65 | 10.74 | 85.59 | 0.34 |

For the steel substrates thus coated, GD-OES (Glow Discharge Optical Emission Spectroscopy) was then used to determine the element contents of the protective coating. This can then be used to ascertain the iron- and manganese-free proportions by mass of the respective elements. The results of this are shown in table 3.

TABLE 3
Iron- and manganese-free proportions by mass of the protective
coating of the coated steel substrates (flat steel products)

| Variant | Zn | Al | Si | Mg |
|---|---|---|---|---|
| A | 0.2% | 88.4% | 11.4% | 0.0%* |
| B | 1.0% | 87.5% | 11.2% | 0.3% |
| C | 1.7% | 87.7% | 10.3% | 0.3% |
| D | 0.3% | 93.8% | 5.8% | 0.1% |

*contents below the detection limit

Variant A is accordingly not in accordance with the invention since the iron- and manganese-free proportion by mass of zinc is outside the inventive range at 0.2%. The variant serves as a comparative sample.

As well as the element contents throughout the protective coating, GD-OES was additionally used to determine the element contents in the near-surface region (i.e. in the uppermost 500 nm). The results are reported in table 4 below:

TABLE 4
Element contents of the protective coating of the
coated steel substrates in the near-surface region

| | Zr | Fe | Al | Si | Mg | Mn |
|---|---|---|---|---|---|---|
| | [% by | [% by | [% by | [% by | [% by | [% by |
| Variant | wt.] | wt.] | wt.] | wt.] | wt.] | wt.] |
| A | 0.9 | 1.3 | 72.3 | 25.5 | 0.0* | 0.0* |
| B | 1.2 | 1.7 | 72.8 | 23.7 | 0.6 | 0.0* |
| C | 2.1 | 1.9 | 78.1 | 16.3 | 0.8 | 0.8 |
| D | 1.4 | 2.8 | 70.0 | 25.2 | 0.6 | 0.0* |

*contents below the detection limit

The flat steel products thus prepared, i.e. the coated steel substrates, were then heated to a heating temperature of 920° C., which is greater than Ac3. They were held at this heating temperature for a hold time between 5 and 10 minutes, and then hot-formed to steel components. The heating and holding were conducted in a roller hearth furnace with closed-loop dewpoint control. The dewpoint was set to 15° C. The whole process took place under ambient atmosphere. Subsequently, the flat steel products were formed in a tool to give steel components and quenched to room temperature. The cooling rate was more than 50° C. per second. Table 5 below summarizes the process parameters of the heat treatment once again:

TABLE 5
Process parameters of heat treatment

| | Sheet | Heating | | | | | Cooling |
|---|---|---|---|---|---|---|---|
| | thickness | temperature | Hold time | Dewpoint | | | rate |
| Variant | [mm] | [° C.] | [min] | [° C.] | Atmosphere | Furnace | [° C./s] |
| A | 1.5 | 920 | 5 | 15 | air | roller hearth | >50 |
| | | | | | | furnace | |
| B | 1.5 | 920 | 5 | 15 | air | roller hearth | >50 |
| | | | | | | furnace | |
| C | 1.5 | 920 | 10 | 15 | air | roller hearth | >50 |
| | | | | | | furnace | |
| D | 1.5 | 920 | 5 | 15 | air | roller hearth | >50 |
| | | | | | | furnace | |

The steel components thus produced were reanalyzed in a next step. This involved first determining the element contents of the protective coating by GD-OES, and determining the iron- and manganese-free proportions by mass therefrom.

TABLE 6
Iron- and manganese-free proportions by mass of
the protective coating of the steel components

| Variant | Zn | Al | Si | Mg |
|---|---|---|---|---|
| A | 0.1% | 90.2% | 9.7% | 0.0%* |
| B | 1.6% | 89.0% | 9.2% | 0.2% |
| C | 1.5% | 88.9% | 9.3% | 0.3% |
| D | 0.6% | 89.0% | 10.2% | 0.2% |

*contents below the detection limit

Here too, it is apparent that variant A is not in accordance with the invention, since the iron- and manganese-free proportion by mass of zinc is outside the inventive range at 0.1%.

As well as the element contents throughout the protective coating, GD-OES was additionally used to determine the element contents in the near-surface region (i.e. in the uppermost 500 nm). The results are reported in table 7 below:

TABLE 7
Element contents of the protective coating of
the steel components in the near-surface region

| | Zn | Fe | Al | Si | Mg | Mn |
|---|---|---|---|---|---|---|
| | [% by | [% by | [% by | [% by | [% by | [% by |
| Variant | wt.] | wt.] | wt.] | wt.] | wt.] | wt.] |
| A | 1.0 | 35.0 | 59.0 | 4.6 | 0.1 | 0.3 |
| B | 19.2 | 27.2 | 47.5 | 1.9 | 4.0 | 0.2 |
| C | 12.9 | 32.6 | 49.9 | 1.2 | 3.1 | 0.3 |
| D | 4.7 | 36.1 | 50.5 | 5.3 | 3.1 | 0.3 |

It is clearly apparent that variants B, C and D have a near-surface first Zn-rich layer with a Zn content higher than the average Zn content of the protective coating. The average Zn content of the protective coating is in any case lower than the Zn content of the melt, and in variants B and C, for example, is therefore less than 2.26% by weight. As a result of the diffusion process, the average Zn content can only fall further since no Zn is supplied. Moreover, the Zn content of the first Zn-rich layer in all three variants B, C and D is 5% or more. Zinc has been significantly concentrated in the near-surface region. FIG. 1 shows, by way of example for variant B, an electron micrograph of the surface of the protective coating. It is clearly apparent that the surface is formed mainly from accumulations of Zn in metallic and/or oxidic form, in the form of small crystallites distributed over the surface. The area proportion of the Zn accumulations was determined by image analysis as 56% for variant B, and as 58% and 16% for variants C and D respectively.

FIG. 2 shows, by way of example for variant B, an electron micrograph of the surface of the protective coating after phosphation. A uniform, continuous phosphate layer is clearly apparent.

FIG. 3 shows a schematic diagram of a section of variant B that can be recorded by scanning electron microscopy. The steel component 11 shown consists of a steel substrate 13 and a protective coating 15. The protective coating 15 comprises a low-silicon phase A and a silicon-rich phase R, with the silicon-rich phase R in insular distribution in the low-silicon phase A. By means of energy-dispersive x-ray spectroscopy (EDX), the Zn content in the two phases was determined. It has been found that concentration of zinc takes place here too in the low-silicon phases. The results are shown in table 8 below.

TABLE 8
Zn contents and Si contents of the
silicon-rich and low-silicon phases

| | |
|---|---|
| Low-silicon phase | Silicon-rich phase |

| | Zn | Si | Zn | Si |
|---|---|---|---|---|
| Variant | [% by wt.] | [% by wt.] | [% by wt.] | [% by wt.] |
| A | 0.1 | 2.6 | 0.0 | 11.3 |
| B | 0.7 | 2.3 | 0.4 | 13.1 |
| C | 0.6 | 2.1 | 0.2 | 12.2 |
| D | 0.3 | 2.0 | 0.1 | 11.6 |

It is clearly apparent that the Zn contents of the low-silicon phase are between 25% and 60% of the Zn content of the melt. For variant B the ratio of the Zn contents of low-silicon phase and melt is 30.1%, for variant C 26.5%, and for variant D 46.1%.

The steel components that had thus been hot-formed were phosphated in a next step. For this purpose, the samples were subjected to a standard industrial phosphation treatment. This comprised the following partial steps:
degreasing in a degreasing bath at a temperature of 60° C. for 150 s. The degreaser used was Chemetall Gardoclean S 5176.
activating the surface with Chemetall Gardolene ZL 6 for 30 s. The activator concentration was 6 g/l.
phosphating in a phosphation bath at a temperature of 60° C. for 150 s. The phosphating agent used was Chemetall Gardobond 24.

On conclusion of the phosphation, the element contents in the near-surface region (i.e. in the uppermost 500 nm) were again determined. The results are given in table 9 below:

TABLE 9
Element contents of the protective coating of the phosphated
steel components in the near-surface region

| | Zn | Fe | Al | Si | Mg | Mn | P |
|---|---|---|---|---|---|---|---|
| Vari- | [% by | [% by | [% by | [% by | [% by | [% by | [% by |
| ant | wt.] | wt.] | wt.] | wt.] | wt.] | wt.] | wt.] |
| A | 1.4 | 44.1 | 48.4 | 5.0 | 0.1 | 0.6 | 0.4 |
| B | 30.7 | 26.6 | 33.4 | 2.0 | 0.7 | 1.1 | 5.5 |
| C | 21.6 | 31.6 | 39.9 | 1.4 | 1.1 | 0.9 | 3.5 |
| D | 13.3 | 37.4 | 39.5 | 5.5 | 0.8 | 0.8 | 2.7 |

It is again clearly apparent that variants B, C and D have a near-surface first Zn-rich layer having a Zn content higher than the average Zn content of the protective coating listed in table 6.

Moreover, the Zn content of the first Zn-rich layer in all three variants B, C and D is 5% or more. The values are even higher than before phosphation. However, this is because material was applied in the course of phosphation, such that the measurement range of thickness 500 nm has moved even more into the region having a very high zinc content.

In addition, it is clearly apparent that variants B, C and D show improved phosphation characteristics. The near-surface phosphorus contents are more than a factor of 5 above comparative sample A.

TABLE 10
Steel compositions

| Steel type | min/max | C | Si | Mn | P | S | Al | Nb | Ti | Cr + Mo | B |
|---|---|---|---|---|---|---|---|---|---|---|---|
| A | min | 0.05 | 0.05 | 0.50 | 0.000 | 0.000 | 0.015 | 0.005 | 0.000 | | 0.0000 |
| | max | 0.10 | 0.35 | 1.00 | 0.030 | 0.025 | 0.075 | 0.100 | 0.150 | | 0.0050 |
| B | min | 0.05 | 0.03 | 0.50 | 0.000 | 0.000 | 0.015 | 0.005 | 0.000 | | 0.0000 |
| | max | 0.10 | 0.50 | 2.00 | 0.030 | 0.025 | 0.075 | 0.100 | 0.150 | | 0.0050 |
| C | min | 0.05 | 0.05 | 1.00 | 0.000 | 0.000 | 0.015 | 0.005 | 0.000 | 0.00 | 0.0010 |
| | max | 0.16 | 0.40 | 1.40 | 0.025 | 0.010 | 0.150 | 0.050 | 0.050 | 0.50 | 0.0050 |
| D | min | 0.10 | 0.05 | 1.00 | 0.000 | 0.000 | 0.005 | | 0.000 | 0.00 | 0.0010 |
| | max | 0.30 | 0.40 | 1.40 | 0.025 | 0.010 | 0.050 | | 0.050 | 0.50 | 0.0050 |
| E | min | 0.250 | 0.10 | 1.00 | 0.000 | 0.000 | 0.015 | | 0.000 | 0.00 | 0.0010 |
| | max | 0.380 | 0.40 | 1.40 | 0.025 | 0.010 | 0.050 | | 0.050 | 0.50 | 0.0500 |

1.-12. (canceled)

13. A steel component comprising:
a steel substrate composed of a steel having 0.1-3% by weight of Mn, and
an Al-based protective coating applied to the steel substrate and having an overall iron- and manganese-free proportion by mass of up to 30% by weight of additional alloy constituents, wherein the additional alloy constituents include Si, Mg and Zn, wherein the iron- and manganese-free proportion by mass of Si in the Al-based protective coating as an additional alloy constituent is between 3% and 15% by weight, wherein the iron- and manganese-free proportion by mass of Mg in the Al-based protective coating as an additional alloy constituent is up to 1.0% by weight, wherein the iron- and manganese-free proportion by mass of Zn in the Al-based protective coating as an additional alloy constituent is between 0.4% and 25.0% by weight, wherein the Al-based protective coating has a near-surface first Zn-rich layer having a Zn content higher than an average Zn content of the Al-based protective coating, and wherein the Zn content of the first Zn-rich layer is more than 5% by weight, and wherein a layer thickness of the Al-based protective coating is at least 5 μm and the near-surface layer extends over a region having a thickness of 500 nm that adjoins a surface of the Al-based protective coating.

14. The steel component of claim 13, wherein the steel further comprises up to 0.01% by weight of B.

15. The steel component of claim 13, wherein the iron- and manganese-free proportion by mass of Si in the Al-based protective coating is between 6% and 12% by weight.

16. The steel component of claim 13, wherein the iron- and manganese-free proportion by mass of Mg in the Al-based protective coating adds up to at least 0.10% or at least 0.15% by weight, and/or the iron- and manganese-free proportion by mass of Mg in the Al-based protective coating adds up to at most 0.50% or at most 0.35% by weight, and/or the iron- and manganese-free proportion by mass of Zn in the Al-based protective coating adds up to at least 0.6% or at least 1.0% by weight, and/or the iron- and manganese-free proportion by mass of Zn in the Al-based protective coating adds up to at most 5.0% or at most 2.3% by weight, and/or the Zn content of the first Zn-rich layer is more than 10.0% by weight or more than 18% by weight.

17. The steel component of claim 13, wherein the surface of the Al-based protective coating is formed mainly from Zn accumulations in metallic and/or oxidic form.

18. The steel component of claim 13, wherein the Al-based protective coating comprises a low-silicon phase (A) and a silicon-rich phase (R), where the silicon-rich phase has an insular distribution in the low-silicon phase, where the Zn content of the silicon-rich phase is less than 90% of an average Zn content of the Al-based protective coating, and the Zn content of the low-silicon phase is more than 105% of the average Zn content of the Al-based protective coating.

19. The steel component of claim 18, wherein the Si content of the low-silicon phase is less than 10% by weight, less than 7% by weight, or less than 5% by weight.

20. The steel component of claim 18, wherein the Si content of the silicon-rich phase is greater than 10% by weight or greater than 12% by weight.

21. A flat steel product for hot forming, comprising:
a steel substrate composed of a steel having 0.1-3% by weight of Mn; and
an Al-based protective coating applied to the steel substrate and having an overall iron- and manganese-free proportion by mass of up to 30% of additional alloy constituents, wherein the additional alloy constituents include Si, Mg and Zn, wherein the iron- and manganese-free proportion by mass of Si in the Al-based protective coating as an additional alloy constituent is between 3% and 15% by weight, wherein the iron- and manganese-free proportion by mass of Mg in the Al-based protective coating as an additional alloy constituent is between 0.10% and 0.50% by weight, and wherein the iron- and manganese-free proportion by mass of Zn in the Al-based protective coating as an additional alloy constituent is between 0.4% and 5% by weight.

22. The flat steel product of claim 21, wherein the steel further comprises up to 0.01% by weight of B.

23. The flat steel product of claim 21, wherein the iron- and manganese-free proportion by mass of Si in the Al-based protective coating is between 6% and 12% by weight.

24. The flat steel product of claim 21, wherein the iron- and manganese-free proportion by mass of Mg in the Al-based protective coating is between 0.1% and 0.35% by weight.

25. The flat steel product of claim 21, wherein the iron- and manganese-free proportion by mass of Zn in the Al-based protective coating is between 0.4% and 2.3% by weight.

26. The flat steel product of claim 21, wherein the Al-based protective coating has been applied by hot dip coating.

27. A method of producing a phosphated steel component, comprising:
providing a steel substrate composed of a steel having 0.1-3% by weight of Mn; and
hot dip coating the steel substrate by means of a melt having an Al-based protective coating that has an overall iron- and manganese-free proportion by mass of up to 30% by weight of additional alloy constituents, wherein the additional alloy constituents include Si, Mg and Zn, wherein the iron- and manganese-free proportion by mass of Si in the Al-based protective coating as an additional alloy constituent is between 3% and 15% by weight, wherein the iron- and manganese-free proportion by mass of Mg in the Al-based protective coating as an additional alloy constituent is up to 1% by weight, wherein the iron- and manganese-free proportion by mass of Zn in the Al-based protective coating as an additional alloy constituent is between 0.4% and 25.0% or between 0.4% and 5% by weight.

28. The method of claim 27, wherein the steel further comprises up to 0.01% by weight of B.

29. The method of claim 27, wherein the iron- and manganese-free proportion by mass of Si in the Al-based protective coating is between 6% and 12% by weight.

30. The method of claim 27, further comprising:
heating the coated steel substrate to a heating temperature of at least 700° C. for the hot forming operation and holding it at the heating temperature, such that diffusion results in concentration of Zn with formation of metallic and oxidic Zn accumulations at a surface of the Al-based protective coating;
hot forming the coated steel substrate to the steel component; and
phosphating the hot-formed steel component.

31. The method of claim 27, wherein during the heating and holding, diffusion results in formation of a low-silicon phase (A) and a silicon-rich phase (R), where the silicon-rich phase has an insular distribution in the low-silicon phase, and where the Zn content of the low-silicon phase is between 25% and 60% by weight of the melt.

32. The method of claim 27, wherein the heating temperature is greater than an austenitization (Ac3) temperature, such that the microstructure of the steel substrate is austenitic, and wherein the coated steel substrate is quenched after hot forming or in the course of hot forming, such that hardness microstructure is formed in the microstructure of the steel substrate of the flat steel product.
